(19) United States
(12) Patent Application Publication
(10) Pub. No.: US 2016/0055031 A1
(43) Pub. Date: Feb. 25, 2016

(54) Dual-System Architecture With Fast Recover And Switching Of Operating System

(71) Applicant: MediaTek Inc., Hsinchu (TW)

(72) Inventors: Li-Chun Tu, Hsinchu City (TW); Yu-Cheng Hsieh, Hsinchu (TW); Chih-Hsiang Hsiao, Taipei (TW); Yen-Lin Lee, Zhubei City (TW)

(21) Appl. No.: 14/931,500

(22) Filed: Nov. 3, 2015

Related U.S. Application Data
(60) Provisional application No. 62/079,074, filed on Nov. 13, 2014.

(51) Int. Cl. G06F 9/48; G06F 9/44

(52) U.S. Cl. CPC G06F 9/4881; G06F 9/4403

(57) ABSTRACT

Examples of a dual-system architecture capable of fast switching between the operating systems are provided. A first operating system may perform one or more operations associated with an apparatus as an active operating system of the apparatus. The active operating system may be switched from the first operating system to a second operating system for the second operating system to perform a task responsive to a determination that the second operating system is required to perform the task.

### CROSS REFERENCE TO RELATED PATENT APPLICATION

The present disclosure claims the priority benefit of U.S. Provisional Patent Application No. 62/079,074, filed on 13 Nov. 2014, which is incorporated by reference in its entirety.

### TECHNICAL FIELD

The present disclosure is generally related to computer architecture and, more particularly, to a dual-system architecture capable of fast switching between the operating systems.

### BACKGROUND

Unless otherwise indicated herein, approaches described in this section are not prior art to the claims listed below and are not admitted to be prior art by inclusion in this section.

In present day, more and more portable electronic apparatuses, such as smartwatches, smartphones and tablet computers, are capable of performing a variety of functionalities. For example, a smartwatch or a smartphone may be able to execute a plethora of mobile apps in addition to simpler functions such as keeping and displaying the time of the day. Even when not executing complex tasks such as executing a mobile app, the operating system of a portable electronic apparatus may still consume a considerable amount of power over time. This is detrimental to the up time of the apparatus given the limited amount of electricity stored in the battery thereof.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

In one example implementation, a method may involve performing one or more operations associated with an electronic apparatus with a first operating system as an active operating system of the electronic apparatus. The method may also involve determining whether a second operating system is required to perform a task. The method may further involve switching the active operating system from the first operating system to the second operating system for the second operating system to perform the task responsive to a determination that the second operating system is required to perform the task.

In another example implementation, a method may involve performing one or more operations associated with an electronic apparatus with a first operating system as an active operating system of the electronic apparatus. The method may involve receiving a signal indicative of a need to perform a task. The method may also involve determining whether a second operating system is required to perform the task. The method may further involve switching the active operating system from the first operating system to the second operating system for the second operating system to perform the task responsive to a determination that the second operating system is required to perform the task.

In yet another example implementation, an apparatus may include a first memory, a second memory, a first circuit associated with a first operating system, and a second circuit associated with a second operating system. The first circuit may be configured to perform one or more operations associated with the apparatus with the first operating system as an active operating system of the apparatus. A central processing unit (CPU) of the first circuit may be configured to determine whether the second operating system is required to perform a task. The CPU may be also configured to switch the active operating system from the first operating system to the second operating system to perform the task responsive to a determination that the second operating system is required to perform the task.

Accordingly, implementations in accordance with the present disclosure may utilize a dual-system architecture that supports a first operating system, which may be a simple application system that consumes relatively less power, and a second operating system, which may be a rich application system that consumes relatively more power. Implementations in accordance with the present disclosure may keep the first operating system running during normal operations while keeping the second operating system inactivated, and can expeditiously switch to the second operating system when necessary (e.g., to execute relatively more complex operations). That is, implementations in accordance with the present disclosure may utilize a fast store/recovery mechanism to restore the inactivated operating system once needed. Advantageously, the overall power saving may be improved without compromising the capability of executing relatively complex operations.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example environment in which various implementations in accordance with the present disclosure may be implemented.

FIG. 2 is a block diagram of an example architecture in accordance with an implementation of the present disclosure.

FIG. 3 is a flowchart of an example algorithm in accordance with an implementation of the present disclosure may be implemented.

FIG. 4 is a simplified block diagram of an example apparatus in accordance with an implementations of the present disclosure.

FIG. 5 is a simplified block diagram of an example apparatus in accordance with another implementations of the present disclosure.

FIG. 6 is a flowchart of an example process in accordance with an implementation of the present disclosure.

FIG. 7 is a flowchart of an example process in accordance with another implementation of the present disclosure.

### DETAILED DESCRIPTION OF PREFERRED EMBODIMENTS

### Overview

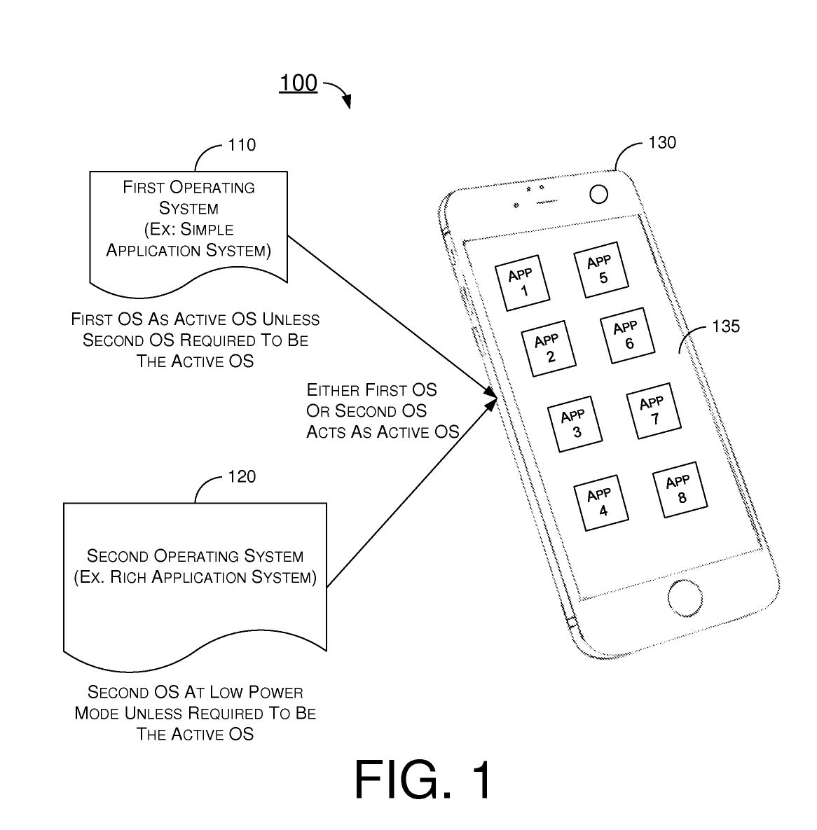

FIG. 1 illustrates an example environment 100 in which various implementations in accordance with the present disclosure may be implemented. Example environment 100 may include a portable electronic apparatus 130, e.g., a smartphone, a tablet computer or another type of apparatus suitable for implementation of techniques described herein. In some implementations, portable electronic apparatus 130 may be wearable by a user and thus considered a wearable apparatus such as, for example and not limited to, a smartwatch. In the example shown in FIG. 1, portable electronic apparatus 130 is a smartphone. Portable electronic apparatus 130 may include a user interface unit 135 capable of providing (e.g., displaying) information to a user and receiving input from the user. User interface unit 135 may include, for example, a touch-sensing panel, a display panel, a keypad, one or more buttons, one or more speakers, one or more microphones, or any combination thereof.

Portable electronic apparatus 130 may support multiple operating systems in accordance with the present disclosure. In the example shown in FIG. 1, portable electronic apparatus 130 supports and is installed with a first operating system 110 and a second operating system 120. In various other implementations, more than two operating systems may be supported by and installed on portable electronic apparatus 130 and, thus, the architecture, scheme, technique, framework and platform described herein also apply to implementations in which there are more than two operating systems.

First operating system 110 may be a simple application system, and second operating system 120 may be a rich application system. Second operating system 120 may be larger or more complex than first operating system 110 with respect to one or more characteristics of a number of characteristics of each of first operating system 110 and second operating system 120. For instance, second operating system 120 may be larger or more complex than first operating system 110 in terms of one or more of characteristics including, but not limited to, power consumption, usage time, memory requirement, processing speed, and startup time. At least a portion of first operating system 110 may be, include or otherwise overlap with at least a portion of second operating system 120, and vice versa.

For illustrative purpose and not limiting the scope of the present disclosure, first operating system 110 may require no more than 300 MB of memory and second operating system 120 may require at least 1 GB of memory, first operating system 110 may consume standby current at no more than 0.1 mA and second operating system 120 may consume standby current at more than 1 mA, first operating system 110 may require a startup time of no more than 3 seconds and second operating system 120 may require a start time of at least 30 seconds and/or first operating system 110 may allow a usage time of portable electronic apparatus 130 of at least 1 week without recharging the battery thereof and second operating system 120 may allow a usage time of portable electronic apparatus 130 of no more than 3 days without recharging the battery thereof.

As a simple application system, first operating system 110 may be associated with and require a basic circuit including a relatively small central processing unit (CPU) with an operating frequency no more than 500 MHz, relatively simple peripherals, and relatively smaller size of read-only memory (ROM) and random-access memory (RAM). Accordingly, power consumption associated with first operating system 110 may tend to be relatively low. As a rich application system, second operating system 120 may be associated with and require a more complicated circuit including an application CPU with an operating frequency of 1 GHz or more, a graphics processing unit (GPU) for fancy user interface (UI), a dedicated processor for display, a hardware engine for video, and relatively larger size of ROM, RAM and flash memory. Accordingly, power consumption associated with second operating system 120 may tend to be relatively high.

Each of first operating system 110 and second operating system 120 may provide or otherwise be associated with a respective user interface displayed on user interface unit 135 of portable electronic apparatus 130. In such case the user interface associated with first operating system 110 may be configured to be similar or identical to the user interface associated with second operating system 120. Alternatively, both first operating system 110 and second operating system 120 may provide or otherwise be associated with the same user interface. In other words, regardless of which of first operating system 110 or second operating system 120 is the active operating system of portable electronic apparatus 130, the user interface as seen by a user on user interface unit 135 of portable electronic apparatus 130 may provide the same or similar look and feel, so as to provide a consistent user experience.

Portable electronic apparatus 130 may have a number of mobile apps and/or software programs. In the example shown in FIG. 1, portable electronic apparatus 130 has mobile apps App 1, App 2, App 3, App 4, App 5, App 6, App 7 and App 8 installed and operable thereon. For one or more of these mobile apps that are relatively simple and not requiring a significant amount of computation, first operating system 110 may be sufficient to execute such mobile app(s). For one or more other of these mobile apps that are relatively complex and requiring a significant amount of computation, first operating system 110 may not be sufficient and thus second operating system 120 may be required to execute such mobile app(s). As an example, App 1 may be a simple time keeping application, e.g., clock and alarms, and in this case first operating system 110 may be sufficient to execute App 1. As another example, App 6 may be a video playback or gaming app that requires graphics capability and relatively more computation, and in this case second operating system 120 may be required to execute App 6 as first operating system 110 may not be sufficient or otherwise capable to execute App 6. As such, in the example shown in FIG. 1, each mobile apps App 1, App 2, App 3, App 4, App 5, App 6, App 7 and App 8 may correspond to or otherwise require a respective operating system (e.g., App 1 corresponds to first operating system 110 and App 6 corresponds to second operating system 120). In general, each operation pertaining to portable electronic apparatus 130 may correspond to or otherwise require a respective operating system between first operating system 110 and second operating system 120 depending on the system requirement to perform or execute the operation in concern.

Both first operating system 110 and second operating system 120 may be booted up as a part of an initialization process of portable electronic apparatus 130, e.g., during the startup of portable electronic apparatus 130 when powered on. After second operating system 120 is booted up, second operating system 120 may be inactivated (e.g., placed in a low-power mode such as a sleep mode, a hibernation mode or a standby mode) so as to minimize power consumption associated with second operating system 120. With second operating system 120 inactivated, first operating system 110 may act as the active operating system of portable electronic apparatus 130 to perform operations for portable electronic apparatus 130 including, for example and not limited to, receiving user input from a user and providing requested information to the user.

When a task is to be performed, for example, when the user input indicates the desire of the user to perform a certain task (e.g., to execute a certain mobile app or software program, or to utilize certain functionality of portable electronic apparatus 130), first operating system 110 may determine whether such task can be performed by itself or if second operating system 120 is required to perform such task. For instance, if the user input indicates the desire of the user to launch App 6, first operating system 110 may determine that, due to its lack of graphics capability and limited computational resources, second operating system 120 is required to execute App 6. Consequently, in response to a determination that second operating system 120 is required to perform the task, first operating system 110 may activate second operating system 120 and switch the active operating system of portable electronic apparatus 130 from first operating system 110 to second operating system 120. Accordingly, second operating system 120, as the active operating system, can perform the task of launching App 6 and other various operations associated with portable electronic apparatus 130, if necessary. If, on the other hand, the user input indicates the desire of the user to launch App 1, first operating system 110 may determine that itself can launch App 1 since App 1 does not require any resources beyond the capability of first operating system 110. Accordingly, in this case first operating system 110 would remain the active operating system of portable electronic apparatus 130 and carry out the task of launching App 1 and other operations for portable electronic apparatus 130, if necessary.

In some embodiments, in example environment 100, at a given time either first operating system 110 or second operating system 120 may act as the active operating system of portable electronic apparatus 130. The first operating system 110 may be the default active operating system. That is, after second operating system 120 is booted up, second operating system 120 may be inactivated (e.g. placed in a low-power mode) and first operating system 110 may act as the active operating system of portable electronic apparatus 130 to carry out normal operations of portable electronic apparatus 130 unless any part of the additional resources and capabilities associated with second operating system 120 is needed. Second operating system 120 may be activated (e.g. “awaken” from the low-power mode) and switched to be the active operating system of portable electronic apparatus 130 when it is determined that second operating system 120, not first operating system 110, can perform a certain task. Afterwards, second operating system 120 may be inactivated (e.g. placed back in the low-power mode). Advantageously, the overall power saving may be improved without compromising the capability of executing relatively complex operations.

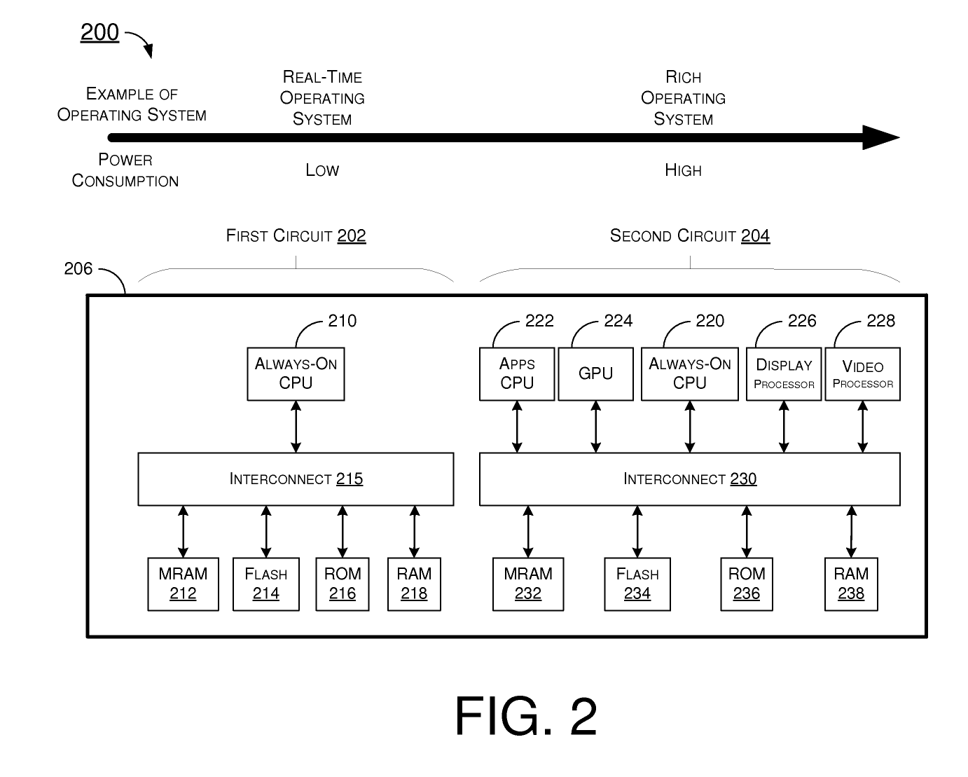

FIG. 2 illustrates an example architecture 200 in accordance with an implementation of the present disclosure. Example architecture 200 may include an example platform 206 that includes a first circuit 202 and a second circuit 204, with first circuit 202 being relatively simpler than second circuit 204 (e.g., with fewer components and/or components of less capacity). First circuit 202 may be configured to support simple application systems with relatively lower power consumption (e.g., real-time operating system, or RTOS). Second circuit 204 may be configured to support rich application systems with relatively higher power consumption (e.g., rich operating systems). Example architecture 200 may be implemented in portable electronic apparatus 130 in example environment 100. Accordingly, first circuit 202 may be associated with or otherwise configured to support first operating system 110, and second circuit 204 may be associated with or otherwise configured to support second operating system 120.

First circuit 202 may include a relatively small CPU, relatively simple peripherals, and relatively smaller size of ROM and RAM. In the example shown in FIG. 2, first circuit 202 includes an always-on CPU 210, a small magnetoresistive RAM (MRAM) 212, a small flash memory 214, a small ROM 216, a small RAM 218 and an interconnect 215 as a communication bus communicatively coupled to always-on CPU 210, MRAM 212, flash memory 214, ROM 216 and RAM 218. Second circuit 204 may include an application CPU, one or more other special-purpose processors, as well as relatively larger size of MRAM, ROM, RAM and flash memory. In the example shown in FIG. 2, second circuit 204 includes an always-on CPU 220, an application CPU 222, a GPU 224, a display processor 226, a video processor 228, a MRAM 232, a large flash memory 234, a large ROM 236 and a large RAM 238. Second circuit 204 also includes an interconnect 230 as a communication bus communicatively coupled to always-on CPU 220, application CPU 222, GPU 224, display processor 226, video processor 228, MRAM 232, flash memory 234, ROM 236 and RAM 238.

Although in the example shown in FIG. 2, example architecture 200 is shown to have two separate circuits, first circuit 202 and second circuit 204, in various implementations of example architecture 200 one or more of the components may be shared between first circuit 202 and second circuit 204. For instance, always-on CPU 210 of first circuit 210 and always-on CPU 220 of second circuit 204 may be replaced with a single always-on CPU that is shared by first circuit 202 and second circuit 204.

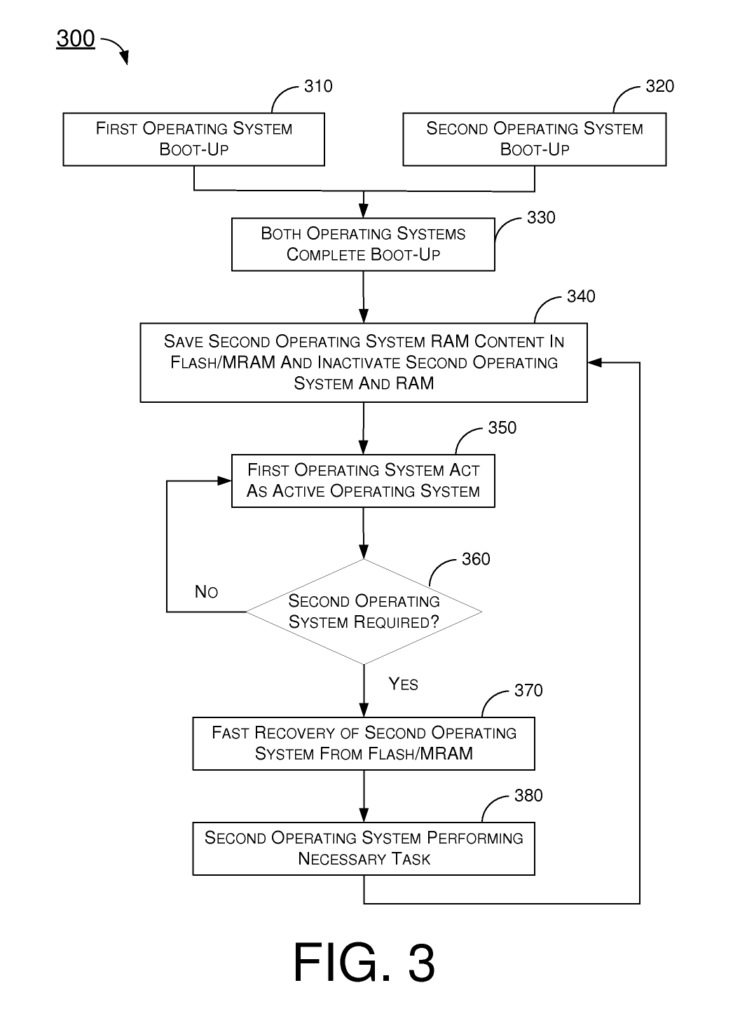

FIG. 3 illustrates an example algorithm 300 in accordance with an implementation of the present disclosure may be implemented. Example algorithm 300 may include one or more operations, actions, or functions as represented by one or more of blocks 310, 320, 330, 340, 350, 360, 370 and 380. Although illustrated as discrete blocks, various blocks of example process 600 may be divided into additional blocks, combined into fewer blocks, or eliminated, depending on the desired implementation. Example algorithm 300 may be implemented in example environment 100 and/or example architecture 200. Example algorithm may begin at 310 and/or 320.

At 310, example algorithm 300 may involve booting up a first operating system (e.g., first operating system 110). At 320, example algorithm 300 may involve booting up a second operating system (e.g., second operating system 120). The booting up of first and second operating systems may be carried out simultaneously (e.g., in parallel) or one after another (e.g., in series). At 330, example algorithm 300 may involve checking or otherwise verifying that both first and second operating systems have been booted up or have otherwise completed the respective startup/boot-up processes. In some implementations, example algorithm 300 may involve checking or otherwise verifying that the second operating system has been booted up or has otherwise completed the startup/boot-up processes. Example algorithm 300 may proceed from 330 to 340.

At 340, example algorithm 300 may involve saving or otherwise storing all RAM (e.g., DRAM) content pertaining to second operating system in a flash memory or a MRAM and inactivating second operating system as well as the RAM used to store the RAM content pertaining to second operating system. Example algorithm 300 may proceed from 340 to 350.

At 350, example algorithm 300 may involve running first operating system to act as the active operating system in responding to all events including, for example and not limited to, exchanging messages, analyzing data from sensor(s), controlling liquid crystal display module (LCM), providing UI as well as other functions. Example algorithm 300 may proceed from 350 to 360.

At 360, example algorithm 300 may determine whether an event, task or operation requires more computing power or resources than what can be provided by first operating system. In an event that it is determined that first operating system can provide sufficient computing power or resources to respond to the event or perform the task or operation, example algorithm 300 may proceed from 360 to 350. In an event that it is determined that first operating system cannot provide sufficient computing power or resources to respond to the event or perform the task or operation, example algorithm 300 may proceed from 360 to 370.

At 370, example algorithm 300 may initiate a fast recovery of second operating system by accessing the flash memory/MRAM which stores the RAM content that was used to boot up second operating system at 320. Upon recovery, second operating system takes the major role as the active operating system. Example algorithm 300 may proceed from 370 to 380.

At 380, example algorithm 300 may involve having second operating system deal with the event, task or operation that requires more computing power or resources than what can be provided by first operating system. After the event, task or operation is completed by second operation system, example algorithm 300 may proceed to 340 to inactivate second operating system and, as a result, first operating system resumes the major role as the active operating system.

### Example Implementations

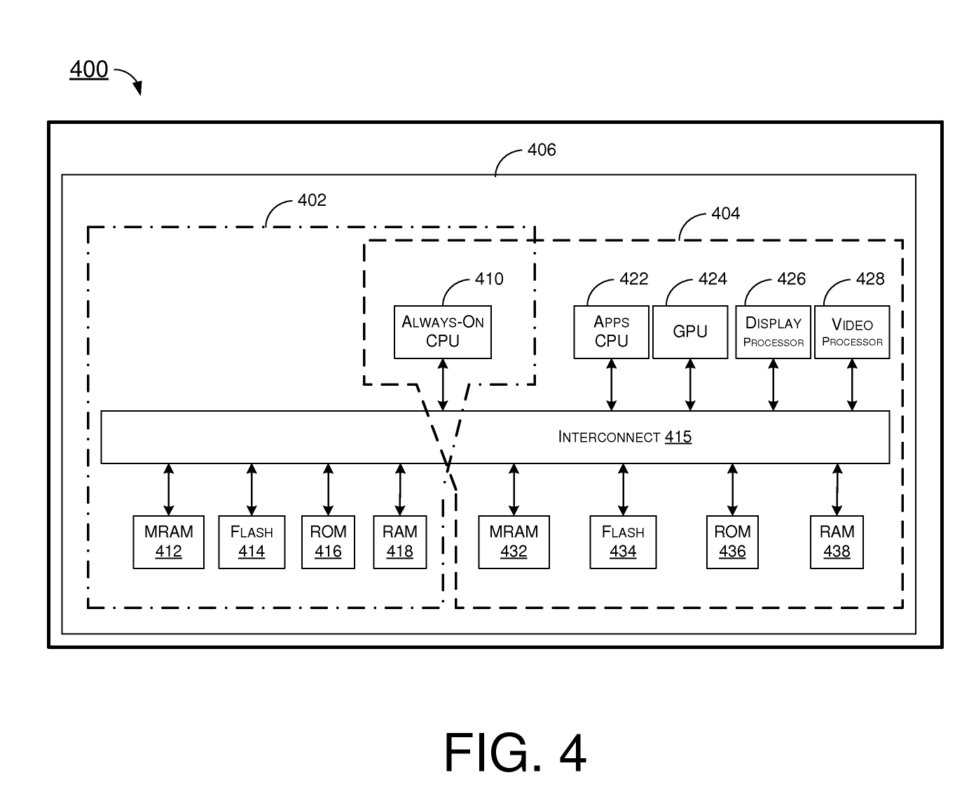

FIG. 4 illustrates an example apparatus 400 in accordance with an implementations of the present disclosure. Example apparatus 400 may include an example platform 406 that includes a first circuit 402 and a second circuit 404, with first circuit 402 being relatively simpler than second circuit 404 (e.g., with fewer components and/or components of less capacity). Example platform 406 may be implemented as a single integrated-circuit (IC) chip, a chip set or multiple discrete and separate IC chips. First circuit 402 may be configured to support simple application systems with relatively lower power consumption (e.g., real-time operating system, or RTOS). Second circuit 404 may be configured to support rich application systems with relatively higher power consumption (e.g., rich operating systems). Example apparatus 400 may be an illustrative implementation of example architecture 200. Example apparatus 400 may also be an illustrative implementation of portable electronic apparatus 130 in example environment 100. Accordingly, first circuit 402 may be associated with or otherwise configured to support first operating system 110, and second circuit 404 may be associated with or otherwise configured to support second operating system 120.

First circuit 402 may include a relatively small CPU, relatively simple peripherals, and relatively smaller size of ROM and RAM. In the example shown in FIG. 4, first circuit 402 includes an always-on CPU 410, a small MRAM 412, a small flash memory 414, a small ROM 416, a small RAM 418 and an interconnect 415 as a communication bus communicatively coupled to always-on CPU 410, MRAM 412, flash memory 414, ROM 416 and RAM 418. Second circuit 404 may include an application CPU, one or more other special-purpose processors, as well as relatively larger size of MRAM, ROM, RAM and flash memory. In example apparatus 400, second circuit 404 may share one or more components with first circuit 402. In the example shown in FIG. 4, second circuit 204 includes always-on CPU 410 which is shared with first circuit 402, an application CPU 422, a GPU 424, a display processor 426, a video processor 428, an MRAM 432, a large flash memory 434, a large ROM 436 and a large RAM 438. Second circuit 404 also includes interconnect 415, which is shared with first circuit 402, as a communication bus communicatively coupled to always-on CPU 410, application CPU 422, GPU 424, display processor 426, video processor 428, MRAM 432, flash memory 434, ROM 436 and RAM 438.

First circuit 402 may be configured to boot up a first operating system (e.g., first operating system 110) and the second circuit 404 may be configured to boot up a second operating system (e.g., second operating system 120) as a part of an initialization process of example apparatus 400. The second operating system may be larger or more complex than the first operating system with respect to one or more characteristics of a number of characteristics of each of the first operating system and the second operating system. These characteristics may include power consumption, usage time, memory requirement, processing speed, and startup time with respect to each of the first operating system and the second operating system. Accordingly, the second operating system may be required when a video playback or gaming application needs to be executed as the first operating system may not have the necessary graphics capability and/or computing power to execute such application.

Second circuit 404 may be configured to inactivate the second operating system after the second operating system is booted up. First circuit 402 may be configured to perform operations associated with example apparatus 400 with the first operating system as an active operating system of example apparatus 400. Always-on CPU 410 may be configured to determine whether the second operating system is required to perform a task, and activate the second operating system responsive to a determination that the second operating system is required to perform the task. Always-on CPU 410 may be also configured to switch the active operating system from the first operating system to the second operating system for the second operating system to perform the operations associated with example apparatus 400, including the task. Always-on CPU 410 may be further configured to switch the active operating system from the second operating system to the first operating system after completion of the task by the second operating system, and inactivate the second operating system.

In some implementations, in booting up the second operating system, second circuit 404 may be configured to decompress data stored in a first memory (e.g., flash memory 434 or MRAM 432), store the decompressed data in a second memory (e.g., MRAM 432 or RAM 438), and access the decompressed data stored in the second memory to boot up the second operating system. The decompressed data may pertain to operations of the second operating system. In some implementations, in inactivating the second operating system, second circuit 404 may be configured to load the decompressed data into the first memory from the second memory, and inactivate the second memory. In some implementations, in activating the second operating system, second circuit 404 may be configured to access the decompressed data stored in the first memory to recover the second operating system. Alternatively or additionally, in activating the second operating system, second circuit 404 may be configured to active the second memory, load the decompressed data into the second memory from the first memory, and access the decompressed data stored in the second memory to recover the second operating system.

Alternatively, when second circuit 404 contains a MRAM (e.g., MRAM 432), as with the example shown in FIG. 4, and the code/data/information needed by the second operating system is stored in the MRAM, there is no need to migrate data for inactivating/activating the second operating system (since the data in MRAM will not disappear). Moreover, the compressed data and the decompressed data may be stored in the same MRAM so that no data migration is needed for booting up the second operating system.

In some implementations, the code/data/information pertaining to operations of the second operating system may be not compressed, so that no decompression is needed for booting up the second operating system.

In some implementations, the second operating system may be in a sleep mode or a power-saving mode when inactivated.

In some implementations, in performing the operations associated with example apparatus 400 with the first operating system as the active operating system of example apparatus 400, first circuit 402 may be configured to execute the first operating system to provide a first user interface similar or identical to a second user interface associated with the second operating system.

In some implementations, in determining whether the second operating system is required to perform the task, always-on CPU 410 may be configured to determine whether the performing of the task requires a computing power or a functionality provided by the second operating system but not the first operating system.

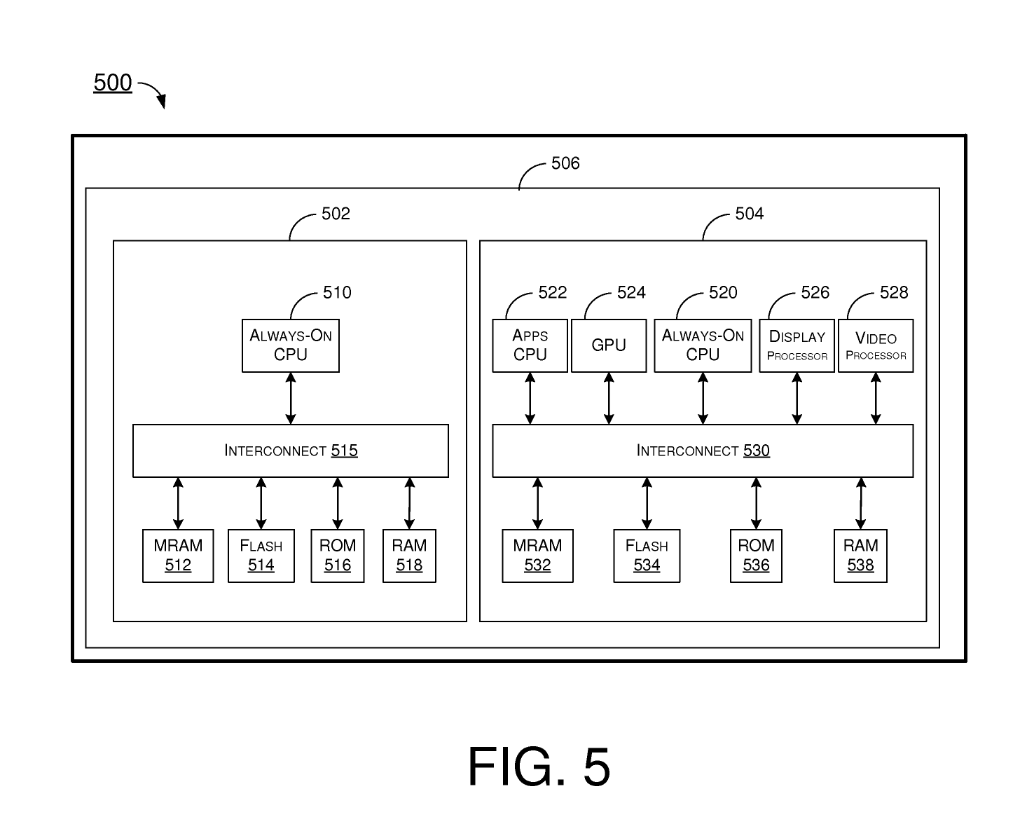

FIG. 5 illustrates an example apparatus 500 in accordance with another implementations of the present disclosure. Example apparatus 500 may include an example platform 506 that includes a first circuit 502 and a second circuit 504, with first circuit 502 being relatively simpler than second circuit 504 (e.g., with fewer components and/or components of less capacity). Example platform 506 may be implemented as a single integrated-circuit (IC) chip, a chip set or multiple discrete and separate IC chips. First circuit 502 may be configured to support simple application systems with relatively lower power consumption (e.g., real-time operating system, or RTOS). Second circuit 504 may be configured to support rich application systems with relatively higher power consumption (e.g., rich operating systems). Example apparatus 500 may be an illustrative implementation of example architecture 200. Example apparatus 500 may also be an illustrative implementation of portable electronic apparatus 130 in example environment 100. Accordingly, first circuit 502 may be associated with or otherwise configured to support first operating system 110, and second circuit 504 may be associated with or otherwise configured to support second operating system 120.

First circuit 502 may include a relatively small CPU, relatively simple peripherals, and relatively smaller size of ROM and RAM. In the example shown in FIG. 5, first circuit 502 includes an always-on CPU 510, a small MRAM 512, a small flash memory 514, a small ROM 516, a small RAM 518 and an interconnect 515 as a communication bus communicatively coupled to always-on CPU 510, MRAM 512, flash memory 514, ROM 516 and RAM 518. Second circuit 504 may include an application CPU, one or more other special-purpose processors, as well as relatively larger size of MRAM, ROM, RAM and flash memory. In the example shown in FIG. 5, second circuit 504 includes an always-on CPU 520, an application CPU 522, a GPU 524, a display processor 526, a video processor 528, an MRAM 532, a large flash memory 534, a large ROM 536 and a large RAM 538. Second circuit 504 also includes interconnect 530 as a communication bus communicatively coupled to always-on CPU 520, application CPU 522, GPU 524, display processor 526, video processor 528, MRAM 532, flash memory 534, ROM 536 and RAM 538.

Example apparatus 500 differs from example apparatus 400 in that first circuit 502 and second circuit 504 are separate circuits that do not share any common component. Other than that, the functionalities and capabilities of each component of first circuit 502 is similar or identical to a corresponding component of first circuit 402. Likewise, the functionalities and capabilities of each component of second circuit 504 is similar or identical to a corresponding component of second circuit 404. Therefore, in the interest of brevity a detailed description of example apparatus 500 is not provided.

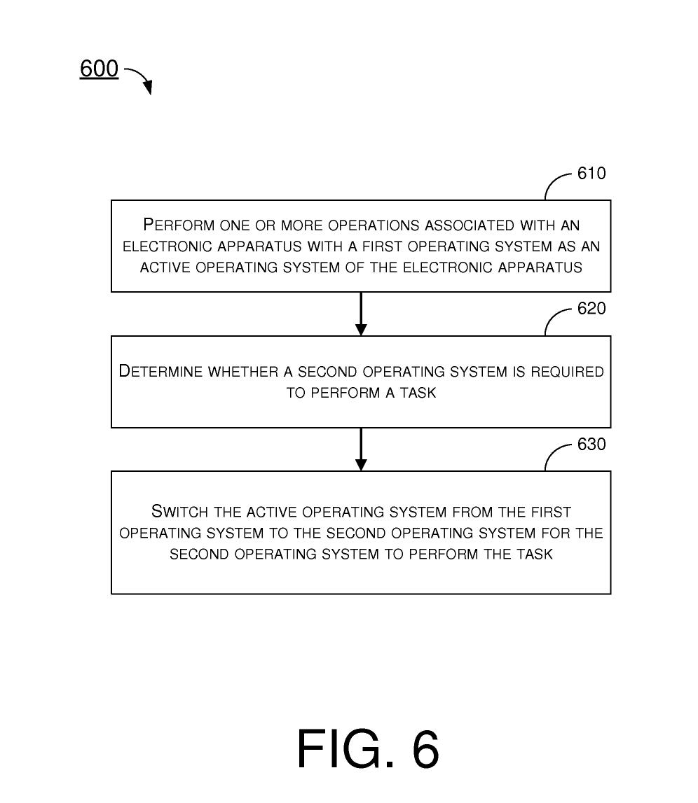

FIG. 6 illustrates an example process 600 in accordance with an implementation of the present disclosure. Example process 600 may include one or more operations, actions, or functions as represented by one or more of blocks 610, 620 and 630. Although illustrated as discrete blocks, various blocks of example process 600 may be divided into additional blocks, combined into fewer blocks, or eliminated, depending on the desired implementation. Example process 600 may be implemented by portable electronic apparatus 130 in example environment 100, example platform 206 in example architecture 200, example apparatus 400 and/or example apparatus 500. For illustrative purposes, operations of example process 600 are described below in the context of being performed by portable electronic apparatus 130 of example environment 100. Example process 600 may begin at 610.

At 610, example process 600 may involve portable electronic apparatus 130 performing one or more operations with first operating system 110 acting as an active operating system of portable electronic apparatus 130. Example process 600 may proceed from 610 to 620.

At 620, example process 600 may involve portable electronic apparatus 130 determining whether second operating system 120 is required to perform a task. Example process 600 may proceed from 620 to 630.

At 630, example process 600 may involve portable electronic apparatus 130 switching the active operating system from first operating system 110 to second operating system 120 for second operating system 120 to perform the task responsive to a determination that second operating system 120 is required to perform the task.

In some implementations, second operating system 120 may be larger or more complex than first operating system 110 with respect to one or more characteristics of a plurality of characteristics of each of first operating system 110 and second operating system 120. The plurality of characteristics may include power consumption, usage time, memory requirement, processing speed, and boot-up time with respect to each of first operating system 110 and second operating system 120. For instance, the second operating system 120 may be required when a video playback or gaming application needs to be executed as the first operating system 110 may not have the necessary graphics capability and/or computing power to execute such application.

In some implementations, example process 600 may further involve portable electronic apparatus 130 booting up first operating system 110 and second operating system 120 as a part of an initialization process of electronic apparatus 130. For instance, in booting up second operating system 120, example process 600 may involve portable electronic apparatus 130 decompressing data stored in a first memory, storing the decompressed data in a second memory, and accessing the decompressed data stored in the second memory to boot up second operating system 120. The decompressed data may pertain to operations of second operating system 120. Alternatively, compressed data may be stored in the second memory and, in booting up second operating system 120, example process 600 may involve portable electronic apparatus 130 decompressing the data stored in the second memory, storing the decompressed data in the second memory, and accessing the decompressed data stored in the second memory to boot up second operating system 120.

In some implementations, example process 600 may further involve portable electronic apparatus 130 inactivating second operating system 120 after the second operating system 120 is booted up. For instance, in inactivating second operating system 120, example process 600 may involve portable electronic apparatus 130 loading the decompressed data into the first memory from the second memory, and inactivating the second memory. Alternatively, the code/data needed by the second operating system may be stored in a MRAM and there is no need to migrate data for inactivating/activating the second operating system (since the data in MRAM will not disappear). Besides, the compressed data and the decompressed data may be stored in the same MRAM so that no data migration is needed for booting up the second operating system.

In some implementations, example process 600 may further involve portable electronic apparatus 130 activating second operating system 120 responsive to the determination that second operating system 120 is required to perform the task. For instance, in activating second operating system 120, example process 600 may involve portable electronic apparatus 130 accessing the decompressed data stored in the first memory or the second memory to recover second operating system 120. Alternatively or additionally, in activating second operating system 120, example process 600 may involve portable electronic apparatus 130 activating the second memory, loading the decompressed data into the second memory from the first memory (or skipping this loading operation in an event that the decompressed data is already stored in the second memory), and accessing the decompressed data stored in the second memory to recover second operating system 120.

In some implementations, the first memory may include a flash memory or an MRAM, and the second memory may include a RAM such as a DRAM, SRAM or MRAM.

In some implementations, in inactivating second operating system 120, example process 600 may involve portable electronic apparatus 130 placing second operating system 120 in a sleep mode or a power-saving mode.

In some implementations, in performing the operations associated with portable electronic apparatus 130 with first operating system 110 as the active operating system of portable electronic apparatus 130, example process 600 may involve first operating system 110 providing a first user interface similar or identical to a second user interface associated with second operating system 120.

In some implementations, in determining whether second operating system 120 is required to perform the task, example process 600 may involve portable electronic apparatus 130 determining whether the performing of the task requires a computing power or a functionality provided by second operating system 120 but not first operating system 110.

In some implementations, example process 600 may also involve portable electronic apparatus 130 switching the active operating system from second operating system 120 to first operating system 110 after completion of the task by second operating system 120, and then inactivating second operating system 120.

In some implementations, example process 600 may further involve performing the task by first operating system 110 responsive to a determination that second operating system 120 is not required to perform the task.

In some implementations, at least a portion of first operating system 110 may include at least a portion of second operating system 120, and vice versa.

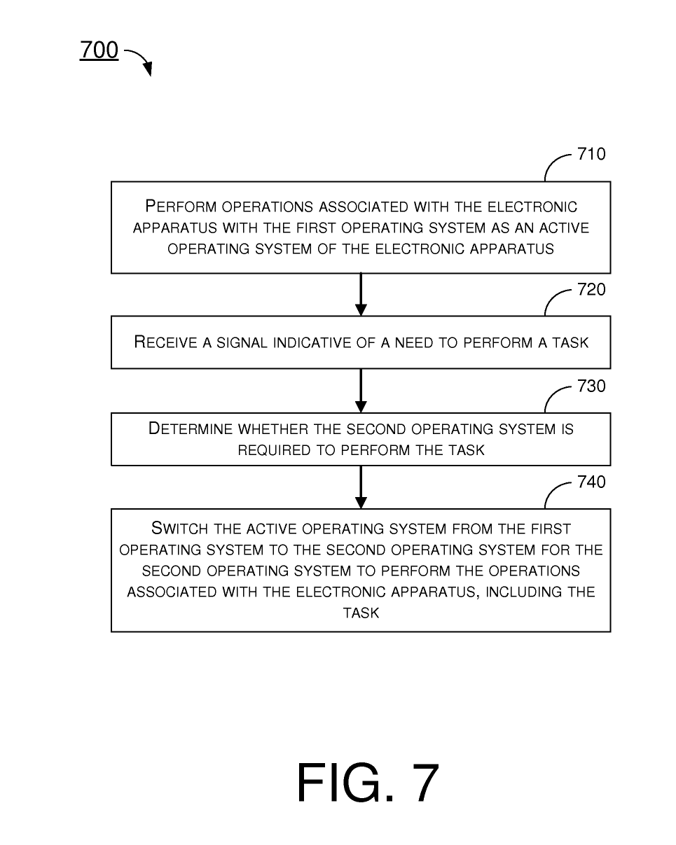

FIG. 7 illustrates an example process 700 in accordance with an implementation of the present disclosure. Example process 700 may include one or more operations, actions, or functions as represented by one or more of blocks 710, 720, 730 and 740. Although illustrated as discrete blocks, various blocks of example process 700 may be divided into additional blocks, combined into fewer blocks, or eliminated, depending on the desired implementation. Example process 700 may be implemented by portable electronic apparatus 130 in example environment 100, example platform 206 in example architecture 200, example apparatus 400 and/or example apparatus 500. For illustrative purposes, operations of example process 700 are described below in the context of being performed by example apparatus 400. Example process 700 may begin at 710.

At 710, example process 700 may involve always-on CPU 410 performing one or more operations associated with apparatus 400 with a first operating system as an active operating system of apparatus 400. Example process 700 may proceed from 710 to 720.

At 720, example process 700 may involve always-on CPU 410 receiving a signal indicative of a need to perform a task. For instance, a user input may indicate a user intent to launch an application. Example process 700 may proceed from 720 to 730.

At 730, example process 700 may involve always-on CPU 410 determining whether a second operating system is required to perform the task. Example process 700 may proceed from 730 to 740.

At 740, example process 700 may involve always-on CPU 410 switching the active operating system from the first operating system to the second operating system for the second operating system to perform the task.

In some implementations, example process 700 may further involve always-on CPU 410 booting up the first operating system and the second operating system as a part of an initialization process of apparatus 400. For instance, in booting up the second operating system, always-on CPU 410 may decompress data stored in a first memory (e.g., ROM 416 or flash 414) or a second memory (e.g., MRAM 432). Moreover, always-on CPU 410 may store the decompressed data in the second memory (e.g., MRAM 432) as the information pertaining to operations of the second operating system. Furthermore, always-on CPU 410 may access the decompressed data stored in the second memory to boot up the second operating system. The second operating system may be larger or more complex than the first operating system with respect to one or more characteristics of a number of characteristics of each of the first operating system and the second operating system. The characteristics may include power consumption, usage time, memory requirement, processing speed, and startup time with respect to each of the first operating system and the second operating system. For instance, the second operating system may be required when a video playback or gaming application needs to be executed as the first operating system may not have the necessary graphics capability and/or computing power to execute such application.

In some implementations, example process 700 may further involve always-on CPU 410 loading information pertaining to operations of the second operating system into the first memory from the second memory after the second operating system is booted up. Alternatively, as the second operating system may operate based on information stored in the second memory (e.g., MRAM 432), there would be no need to load such information from one memory into another memory. Example process 700 may additionally involve second circuit 204 inactivating the second operating system.

In some implementations, example process 700 may further involve always-on CPU 410 recovering the second operating system by accessing the information stored in the first memory (or the second memory if the information is stored in the second memory) responsive to the determination that the second operating system is required to perform the task.

In some implementations, the first memory may include a flash memory or an MRAM, and the second memory may include a RAM such as a DRAM, SRAM or MRAM.

In some implementations, in inactivating the second operating system, example process 700 may involve always-on CPU 410 placing the second operating system in a sleep mode or a power-saving mode.

In some implementations, in performing the one or more operations associated with apparatus 400 with the first operating system as the active operating system of apparatus 400, example process 700 may involve always-on CPU 410 executing the first operating system to provide a first user interface similar or identical to a second user interface associated with the second operating system.

In some implementations, in determining whether the second operating system is required to perform the task, example process 700 may involve always-on CPU 410 determining whether the performing of the task requires a computing power or a functionality provided by the second operating system but not the first operating system.

In some implementations, example process 700 may also involve always-on CPU 410 switching the active operating system from the second operating system to the first operating system after completion of the task by the second operating system. Example process 700 may further involve always-on CPU 410 inactivating the second operating system.

In some implementations, example process 700 may also involve always-on CPU 410 executing the first operating system to perform the task responsive to a determination that the second operating system is not required to perform the task.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing one or more operations associated with an electronic apparatus with a first operating system as an active operating system of the electronic apparatus;
determining whether a second operating system is required to perform a task; and
switching the active operating system from the first operating system to the second operating system for the second operating system to perform the task responsive to a determination that the second operating system is required to perform the task.

2. The method of claim 1, wherein the second operating system is larger or more complex than the first operating system with respect to one or more characteristics of a plurality of characteristics of each of the first operating system and the second operating system, and wherein the plurality of characteristics comprise power consumption, usage time, memory requirement, processing speed, and boot-up time with respect to each of the first operating system and the second operating system.

3. The method of claim 1, further comprising:
booting up the first operating system and the second operating system as a part of an initialization process of the electronic apparatus,
wherein the booting up of the second operating system comprises:
decompressing data stored in a first memory or a second memory;
storing the decompressed data in the second memory, the decompressed data pertaining to operations of the second operating system; and
accessing the decompressed data stored in the second memory to boot up the second operating system.

4. The method of claim 3, further comprising:
inactivating the second operating system after the second operating system is booted up,
wherein the inactivating of the second operating system comprises:
optionally loading the decompressed data into the first memory from the second memory; and
inactivating the second memory.

5. The method of claim 4, further comprising:
activating the second operating system responsive to the determination that the second operating system is required to perform the task by accessing the decompressed data stored in the first memory or the second memory to recover the second operating system.

6. The method of claim 4, further comprising:
activating the second operating system responsive to the determination that the second operating system is required to perform the task by performing operations comprising:
activating the second memory;
loading the decompressed data into the second memory from the first memory; and
accessing the decompressed data stored in the second memory to recover the second operating system.

7. The method of claim 3, wherein the first memory comprises a flash memory or a magnetoresistive random-access memory (MRAM), and wherein the second memory comprises a random-access memory (RAM).

8. The method of claim 4, wherein the inactivating of the second operating system comprises placing the second operating system in a sleep mode or a power-saving mode.

9. The method of claim 1, wherein the performing of the one or more operations associated with the electronic apparatus with the first operating system as the active operating system of the electronic apparatus comprises providing, by the first operating system, a first user interface similar or identical to a second user interface associated with the second operating system.

10. The method of claim 1, wherein the determining of whether the second operating system is required to perform the task comprises determining whether the performing of the task requires a computing power or a functionality provided by the second operating system but not the first operating system.

11. The method of claim 1, further comprising:
switching the active operating system from the second operating system to the first operating system after completion of the task by the second operating system; and
inactivating the second operating system.

12. The method of claim 1, further comprising:
performing the task by the first operating system responsive to a determination that the second operating system is not required to perform the task.

13. The method of claim 1, wherein at least a portion of the first operating system comprises at least a portion of the second operating system.

14. A method, comprising:
performing one or more operations associated with an electronic apparatus with a first operating system as an active operating system of the electronic apparatus;
receiving a signal indicative of a need to perform a task;
determining whether a second operating system is required to perform the task; and
switching the active operating system from the first operating system to the second operating system for the second operating system to perform task responsive to a determination that the second operating system is required to perform the task.

15. An apparatus, comprising:
a first memory;
a second memory;
a first circuit associated with a first operating system; and
a second circuit associated with a second operating system,
wherein the first circuit is configured to perform one or more operations associated with the apparatus with the first operating system as an active operating system of the apparatus;
wherein a central processing unit (CPU) of the first circuit is configured to determine whether the second operating system is required to perform a task; and
wherein the CPU is configured to switch the active operating system from the first operating system to the second operating system for the second operating system to perform the task responsive to a determination that the second operating system is required to perform the task.

16. The apparatus of claim 15, wherein the second operating system is larger or more complex than the first operating system with respect to one or more characteristics of a plurality of characteristics of each of the first operating system and the second operating system, and wherein the plurality of characteristics comprise power consumption, usage time, memory requirement, processing speed, and startup time with respect to each of the first operating system and the second operating system.

17. The apparatus of claim 15, wherein, in performing the one or more operations associated with the apparatus with the first operating system as the active operating system of the apparatus, the first circuit is configured to execute the first operating system to provide a first user interface similar or identical to a second user interface associated with the second operating system.

18. The apparatus of claim 15, wherein, in determining whether the second operating system is required to perform the task, the CPU is configured to determine whether the performing of the task requires a computing power or a functionality provided by the second operating system but not the first operating system.

19. The apparatus of claim 15, wherein the first circuit and the second circuit share one or more components, and wherein the shared one or more components comprise the CPU.

20. The apparatus of claim 15, wherein the first circuit and the second circuit comprise two separate circuits.

21. The apparatus of claim 15, wherein at least a portion of the first operating system comprises at least a portion of the second operating system.
